(19) United States
(12) Patent Application Publication
(10) Pub. No.: US 2014/0006057 A1
(43) Pub. Date: Jan. 2, 2014

(54) PATIENT VIRTUAL ROUNDING WITH CONTEXT BASED CLINICAL DECISION SUPPORT

(71) Applicants: Joseph Ernest Rock, Littleton, MA (US); Mariana Nikolova-Simons, Bolton, MA (US); Amy Oi Mee Cheung, Eindhoven (NL)

(72) Inventors: Joseph Ernest Rock, Littleton, MA (US); Mariana Nikolova-Simons, Bolton, MA (US); Amy Oi Mee Cheung, Eindhoven (NL)

(73) Assignee: KONINKLIJKE PHILIPS N.V., EINDHOVEN (NL)

(21) Appl. No.: 14/004,682

(22) PCT Filed: Mar. 13, 2012
(86) PCT No.: PCT/IB12/51175

§ 371 Date: Sep. 12, 2013

Related U.S. Application Data
(60) Provisional application No. 61/453,148, filed on Mar. 16, 2011.
(60) Provisional application No. 61/453,148, filed on Mar. 16, 2011.

(51) Int. Cl. G06F 19/00

(52) U.S. Cl. CPC G06F 19/322
USPC 705/3

(57) ABSTRACT

A method and computer readable storage medium for identifying context attributes and generating a context-based list of tasks for a user with respect to the identified context attributes. A device having a processor identifying context attributes and generating a context-based list of tasks for a user with respect to the identified context attributes. The device further including a memory storing at least one of clinical guidelines and patient data, wherein the processor generates a master list of tasks with respect to the at least one of the clinical guidelines and patient data.

During hospitalization, a patient moves through a number of care settings and is cared for by a number of different care providers. Patient data is collected during admission and throughout the patient's hospital stay to support the care providers. During hospitalization for cardiovascular disease, for example, patient data is collected during diagnosis, treatment and management in the emergency department, catheterization electrophysiology laboratories, intensive care unit and cardiac patient floor/ward. Patient data may include patient demographics, medical history, diagnosis, signs and symptoms, laboratory results, medication treatment, social support, etc. As a result, an enormous amount of information is associated with each patient.

The patient data is used for guiding medical decisions such as, for example, types of treatment options, necessary modifications to a treatment plan, tests to be ordered, prescribing medications, etc. For example, for the task of prescribing medication, the care professional must be aware of the patient's current medication regimen, medical history, adverse effects (e.g., allergies and drug intolerance), co-morbidities, etc., to be able to make an informed decision. Currently, however, care professionals are required to obtain and filter all of the available data themselves, which is time-consuming and error-prone given the limited amount of time care professionals have per patient. In addition, since the filtering is an implicit process conducted by each care professional, it is unknown whether the most relevant data are utilized to for making the clinical decisions.

The exemplary embodiments include a method for identifying context attributes and generating a context-based list of tasks for a user with respect to the identified context attributes.

The exemplary embodiments further include a device having a processor identifying context attributes and generating a context-based list of tasks for a user with respect to the identified context attributes.

A further exemplary embodiment includes a computer-readable storage medium including a set of instructions executable by a processor. The set of instructions being operable to identify context attributes; and generate a context-based list of tasks for a user with respect to the identified context attributes.

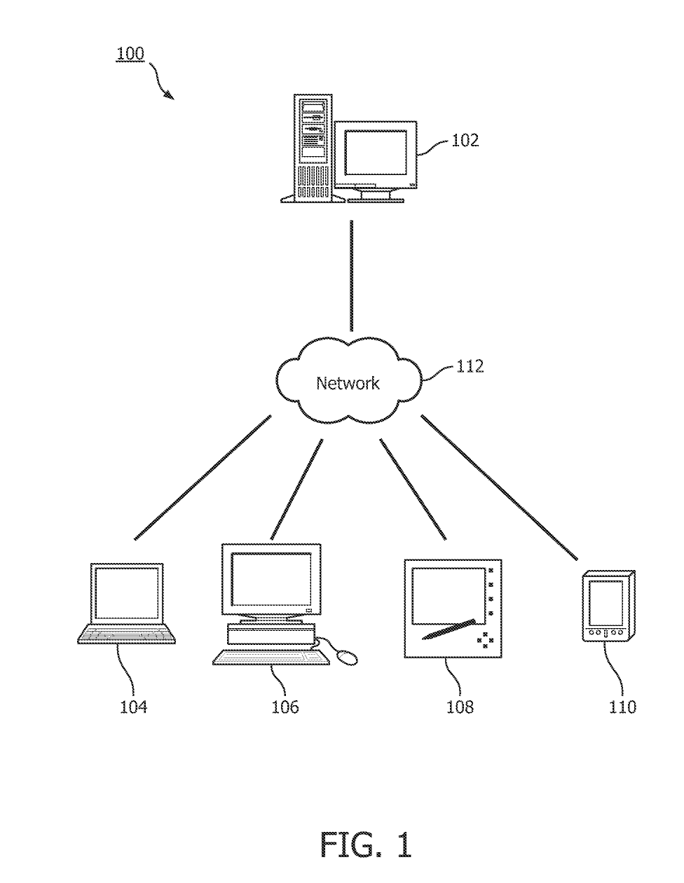

FIG. 1 shows a schematic diagram of a system according to an exemplary embodiment.

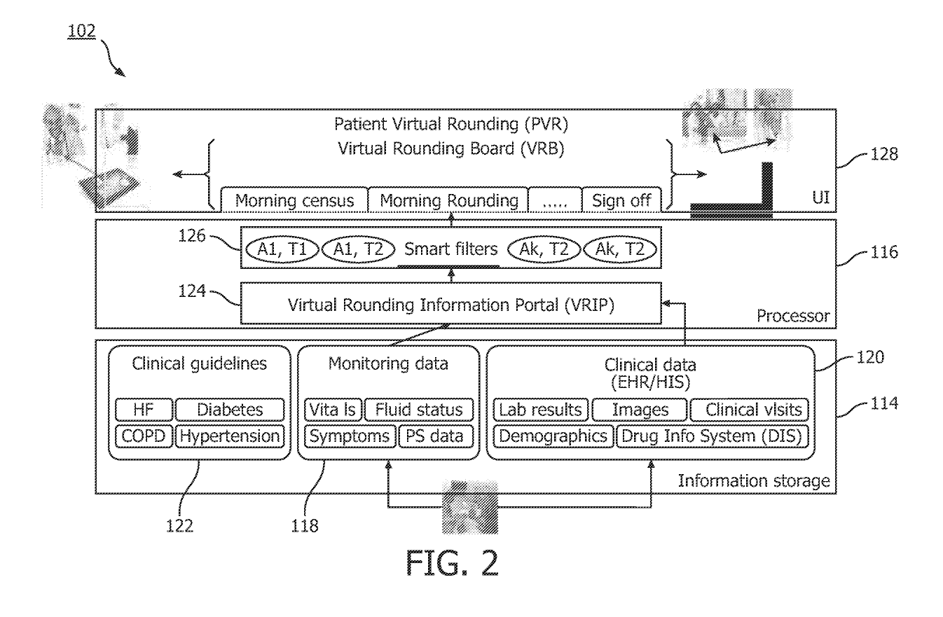

FIG. 2 shows a schematic diagram of a host device of the system of FIG. 1.

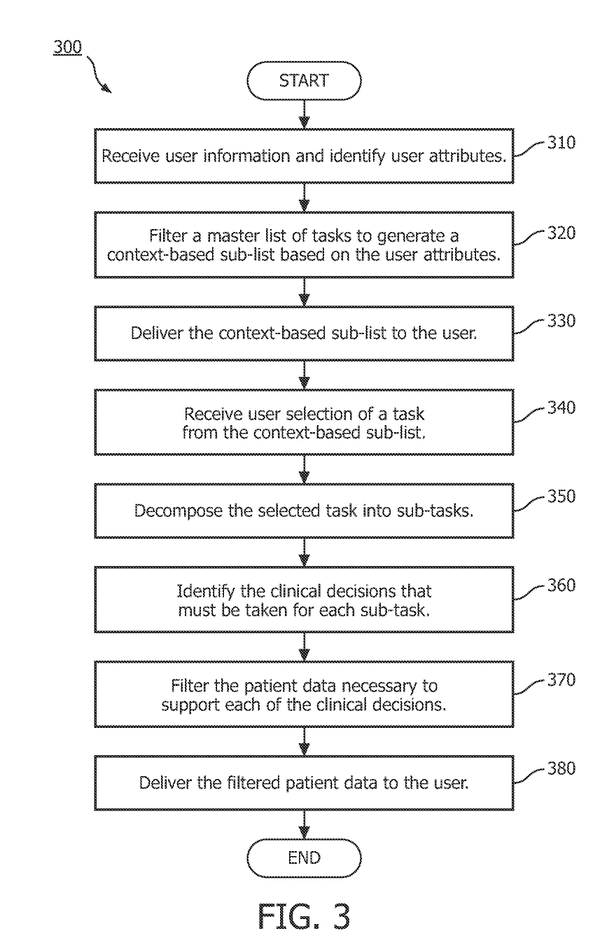

FIG. 3 shows a flow diagram of a context-based clinical decision support method according to an exemplary embodiment.

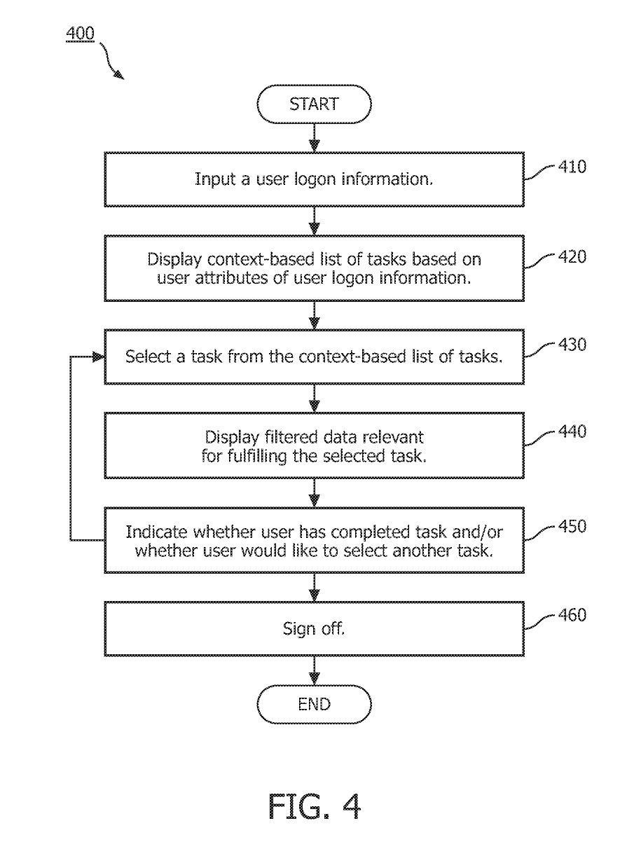

FIG. 4 shows a flow diagram of a user-system method according to an exemplary embodiment.

The exemplary embodiments may be further understood with reference to the following description and the appended drawings, wherein like elements are referred to with the same reference numerals. The exemplary embodiments relate to a context-dependent data filtering for a clinical decision support system and method. In particular, the exemplary embodiments provide a system and method for filtering patient data based upon the context in which a user is interacting with the system to provide only the most relevant data to the user. Although the exemplary embodiments are described with respect to a patient suffering from cardiovascular disease, it will be understood by those of skill in the art that the systems and methods of the exemplary embodiments may be used in any healthcare setting such as, for example, cardio informatics and disease management.

As shown in FIG. 1, a system 100 comprises a host device 102 that may be connected to a plurality of user devices 104-110 via a communications network 112 such as, for example, a wired/wireless LAN/WAN, an intranet, the Internet, GPRS, etc. The user devices 104-110 may, for example, connect to the communications network 112 via a cellular connection, which may issue the user device 104-110 an IP address. The host device 102, as shown in FIG. 2, is a server comprising a processor 114 capable of processing patient data and clinical guidelines stored in an information storage 116 (e.g., a memory) to provide a user (e.g., physician, nurse, discharge planner, administrator) with a context-based list of tasks specific to the user's role, time, location and device, and information relevant to the completion of that task. The user devices 104-110 may be any wired or wireless computing devices that connect to and communicate with the host device 102. The user devices 104-110 include a user interface for displaying the processed information to the user and permitting the user to input information to the host device 102. For example, the user interface may be a graphical user interface displayed to the user on a display and permitting information to be entered via an input device. The user devices 104-110 may be, for example, PCs, laptops, PDAs, smartphones, tablets, etc. It will be understood by those of skill in the art that the system 100 may include any number of user devices 104-110.

As shown in FIG. 2, the information storage 116 stores patient data including monitoring data 118 and clinical data 120 for all patients in the hospital. The monitoring data 118 may include information such as, for example, patient's vitals, fluid status, signs and symptoms and psycho-social data obtained via surveys (e.g., patient's knowledge, motivations, self-care behavior, etc.). The clinical data 120 may include information such as, for example, lab results, images, clinical visits, demographics, and drug information systems. The monitoring data 118 and clinical data 120 may be collected during a patient's stay in the hospital and may be updated with new information as it becomes available. The information storage 116 may also store clinical guidelines 122 for analyzing and evaluating the patient data. The clinical guidelines 122 may be disease and/or condition specific (e.g., heart failure, diabetes, COPD, hypertension). The clinical guidelines 122 may be national and/or international guidelines accepted in the medical field and/or local guidelines established by the hospital or a user of the system 100.

The processor 114 processes the monitoring and clinical data 118, 120 and the clinical guidelines 122 using, for example, a virtual rounding information portal (VRIP) 124. The VRIP 124 accesses the available information in the information storage 114 and generates a master task list of all tasks that could be addressed by a physician, nurse, administrator or other hospital professional. The processor 116 further includes a smart filter 126, which filters the list of tasks generated by the VRIP 124 based on attributes such as, for example, a role of the user, a time of day, a location and a type of device to generate a context-based sub-list of tasks. These context attributes may be provided by the user and/or automatically detected by the host device 102. The smart filter 126 may further filter the available patient data according to a selected task. The filtered information is displayed to the user devices 104-110 via a graphical user interface such as a Virtual Rounding Board 128, which permits user interaction with the host device 102. The Virtual Rounding Board 128 may comprise a number of different views, each view dedicated to the user in a specific role that carries out a particular task at a given location. The Virtual Rounding Board 128 may include tabs, links or other features which may be selected by the user to view a particular task and/or select a desired view.

The Virtual Rounding Board 128 displays the context-based sub-list of tasks generated by the smart filter 126 in a number of different views. The user selects a desired view using the user interface of the user device 104-110. For example, daily master list of tasks for a cardiologist in his/her role as an attendee may include a morning census, morning rounding, review and sign off of clinical documents, which are displayed to the user as separate tabs or links selectable by the user. Each task may have a number of different views, which may also be selected by the user. For example, the morning census task may be viewed as a ward layout, which provides a room-by-room picture based patient index, and/or a patient status with respect to whether or not the patient is ready to be discharged. The morning rounding task may be viewed in, for example, a patient-at-a-glance view, tests ordered, remaining tasks, notes scribing, chat/conference room, video link, and reminders and alerts. The patient-at-a-glance view provides support for tasks such as signs and symptoms management, medication management, care plan management and follow up management, all of which are tailored to the user and the particular task that he/she is carrying out. The tests ordered view shows whether a test has already been or should be ordered and a notification if results are already available. The remaining tasks view shows a list of responsibilities remaining and who from the multi-disciplinary team is responsible for carrying out each of the remaining tasks. The notes scribing task permits the user to leave notes for other members of the team. The chat/conference feature permits multiple users to conference with one another. The video link permits hospital staff to interact with the patients. The reminder and alerts view allows the user to receive, set up and view reminders and/or alerts. The review and sign off of clinical documents task comprises views on clinical notes, medication orders, discharge instruction forms and other types of forms, billing information, etc. It will be understood by those of skill in the art that specific views and the specific tasks described above are exemplary only and may be different depending on the specific role of the user at the specific time and location.

Using a method 300, as shown in FIG. 3, the smart filter 126 filters a master list of tasks to generate a context-based list for the user and present only the patient data (e.g., from the monitoring data 118 and the clinical data 120) that is relevant to a task selected by user. The method 300 comprises receiving information, in a step 310, from the user device 104-110 to identify context attributes. Context attributes may include, for example, a role of the user, a time of day that the user is logging on and a location of the user. These attributes may be identified based upon a user logon information that is received when the user logs on to the network 112 via the user device 104-110. The user logs on to the network 112 by inputting identifying information. The identifying information may be, for example, a hospital-issued logon and password that identifies the specific user. If the user has more than one role in the hospital (e.g., an attendee and an administrator), the user also indicates the specific role in which he/she desires to logon. The processor 116 is also able to determine the location of the user device 104-110 by identifying the unique MAC address of the user device 104-110 the user is using to log on and the physical location of the device issuing the IP address to the user device 104-110. For example, where the MAC address of a wireless telephone and the IP address of a wireless connection issued from the critical care unit, it is most probable that the user is accessing the host device 102 from a patient's room. The first time that each MAC address is connected, the processor 116 may request that the user identify and describe the user device 104-110. The user may identify the type of device (e.g., workstation, handheld, tablet), as well as a location (e.g., home, office, floor), if it is not already known. The processor 116 is also able to determine the specific time of day during which the user is logging on, by accessing a time feature of the host device 102.

As described above, the VRIP 124 utilizes a master list of tasks for all users based on the monitoring and clinical data 118, 120 and the clinical guidelines 122. In a step 320, the smart filter 126 filters this master list of tasks, using the attributes identified in the step 310, to produce a context-based sub-list for the user. In the exemplary embodiment, the context-based sub-list includes tasks specific to the role of the user, the time of day, the location and the type of user device 104-110 that the user is using to log on to the host device 102. The context-based sub-list provides a list of tasks that the specific user is responsible for and most-likely to address given the time of day, location and type of device being used by the user. There are multiple types of users and/or roles that the user may take on. For example, in a cardiovascular domain, users may include cardiologists, internal residents, physician's assistants, nurses, dieticians, physiotherapists, etc. In addition, the user may address different tasks depending on whether he/she is working the morning shift, evening shift or overnight shift. Further, the user is likely to address different tasks depending on a location of the user (e.g., in the operating room, by the patient's bedside, in his/her office, etc. and the type of device being used (e.g., workstation, handheld device). Thus, the context-based sub-list provides a list of tasks specific to role of the user at that specific time and location. In a step 330, the context-based sub-list is delivered to the user device 104-110 of the user and displayed via the user interface of the user device 104-110. As described above, the context-based sub-list can also be displayed to the user via the Virtual Rounding Board 128 of the host device 102.

In a step 340, the processor 116 receives a user selection of a particular task from the context-based sub-list displayed in the step 330. The smart filter 126, in a step 350, will then decompose the selected task to generate a list of sub-tasks. These sub-tasks may be further filtered, in a step 360, to identify clinical decisions that need to be made for each sub-task. For each clinical decision, in a step 370, the smart filter 126 filters all the available patient data, from the monitoring and clinical data 118, 120, so that only the relevant patient data that is necessary to support the clinical decisions identified in the step 360 is produced. The relevant data is delivered to the user device 104-110 for display via the user interface, in a step 380. Thus, based on the filtered information from the smart filter 126, the user may make any decisions required for completion of the selected task.

FIG. 4 shows a method 400 of a user-system flow of the system 100. In a step 410, the user logs in to the network 112 to access the host device 102 by entering a user information from a user device 104-110. As described above, the user information permits the smart filter 126 to identify context attributes to filter the master list of tasks and generate a context based sub-list specific to the context attributes. The user information along with automatically or manually identified context attributes may be used to generate a context-base sub-list of tasks that is displayed to the user in a step 420. The context-based sub-list is specific to the role of the user, time of day, location and the device. The context-based sub-list is displayed to the user on the user device 104-110 via which the user logs in to the network 112. The context-based sub-list may also be displayed via the Virtual Patient Board 128 of the host device 102, as described above.

The user may select a task from the context-based sub-list via the Virtual Patient Board 128, in a step 430. The smart filter 126 then filters the patient data to produce only the patient data relevant to support the clinical decisions required to fulfill the selected task. The relevant data is then displayed to the user via the user device 104-110, in a step 440. The user may review the filtered data to make any clinical decisions required to fulfill the selected task. Once the user has completed the selected task, the user indicates that the task has been completed and/or selects another task, in a step 450. If the task has been completed and the user does not wish to select another task, the user may sign off, in a step 460. If the user indicates that he/she wishes to select another task, the method 400 may return to the step 430. It will be understood by those of skill in the art that the user may select any number of tasks.

It is noted that the claims may include reference signs/numerals in accordance with PCT Rule 6.2(b). However, the present claims should not be considered to be limited to the exemplary embodiments corresponding to the reference signs/numerals.

Those skilled in the art will understand that the above-described exemplary embodiments may be implemented in any number of manners, including, as a separate software module, as a combination of hardware and software, etc. For example, the Virtual Rounding Information Portal 124 and the Smart Filter 126 may be programs containing lines of code that, when compiled, may be executed on a processor.

It will be apparent to those skilled in the art that various modifications may be made to the disclosed exemplary embodiments and methods and alternatives without departing from the spirit or scope of the disclosure. Thus, it is intended that the present disclosure cover modifications and variations provided that they come within the scope of the appended claims and their equivalents.

1. A method, comprising:
identifying context attributes;
generating a context-based list of tasks for a user with respect to the identified context attributes;
receiving a user selection of a task from the context-based list of tasks; and
filtering all available patient data to produce only the patient data that is relevant to the user-selected task.

2. The method of claim 1, further comprising:
generating a master list of tasks with respect to at least one of clinical guidelines and patient data.

3. The method of claim 2, wherein generating the context-based list of tasks includes filtering the master list of tasks to include tasks specific to the context attributes.

4. The method of claim 1, further comprising:
delivering the context-based list of tasks to a user device.

5. The method of claim 1, wherein the context attributes include at least one of a role of the user, a time of day, a location of the user device and a type of user device.

6. The method of claim 1, wherein identifying the context attributes includes identifying a unique address of a user device.

7. (canceled)

8. (canceled)

9. The method of claim 1, further comprising:
decomposing the selected task into sub-tasks.

10. The method of claim 9, further comprising:
identifying clinical decisions required for each sub-task so that the relevant patient data is the patient data necessary to support the identified clinical decisions.

11. The method of claim 1, further comprising:
delivering the relevant patient data to a user device.

12. A device, comprising:
a memory storing set of instructions executable by a processor; and
a processor executing the set of instructions to perform operations comprising:
identifying context attributes; and
generating a context-based list of tasks for a user with respect to the identified context attributes; and
a user interface receiving a user selection of a task from the context-based list of tasks,
wherein operations further comprise filtering all available patient data to produce only the patient data that is relevant to the user-selected task.

13. The device of claim 12, wherein the:
memory stores at least one at least one of clinical guidelines and patient data, and wherein the operations further comprise generating a master list of tasks with respect to the at least one of the clinical guidelines and patient data.

14. The device of claim 12, wherein the operations further comprise delivering the context-based list of tasks to a user device.

15. The device of claim 12, wherein the context attributes include at least one of a role of the user, a time of day, a location of the user device and a type of user device.

16. The device of claim 12, wherein the operations further comprise identifying the context attributes by identifying a unique address of a user device.

17. (canceled)

18. (canceled)

19. The device of claim 1, wherein operations further comprise decomposing the user-selected task into sub-tasks and identifies clinical decisions required for each sub-task.

20. The device of claim 1, wherein the operations further comprise delivery the relevant patient data to a user device.

21. A computer-readable storage medium including a set of instructions executable by a processor, the set of instructions operable to:
identify context attributes;
generate a context-based list of tasks for a user with respect to the identified context attributes;
receive a user selection of a task from the context-based list of tasks; and
filter all available patient data to produce only the patient data that is relevant to the user-selected task.
